(19) United States
(12) Patent Application Publication
(10) Pub. No.: US 2024/0386331 A1
(43) Pub. Date: Nov. 21, 2024

(54) TRUST-AWARE MULTI-VIEW STACKING BASED RISK ASSESSMENT

(71) Applicant: Intuit Inc., Mountain View, CA (US)

(72) Inventors: Yue Yu, Mountain View, CA (US); Wei Wang, Mountain View, CA (US); Aditi Das, Mountain View, CA (US); Luna Wang, Mountain View, CA (US); Lei Chen, Mountain View, CA (US); Atanu Roy, Mountain View, CA (US); Junyan Ge, Mountain View, CA (US); Shenlu Chen, Mountain View, CA (US)

(73) Assignee: Intuit Inc., Mountain View, CA (US)

(21) Appl. No.: 18/320,164

(22) Filed: May 18, 2023

(51) Int. Cl. G06N 20/20; G06F 17/16

(52) U.S. Cl. CPC G06N 20/20; G06F 17/16

(57) ABSTRACT

A method and system are provided for generating a combined prediction using an ensemble machine learning system. The prediction may be used in risk assessment for payroll processing. A data point is received as input to a multitude of trained models. Each model is trained from a respective data subset of a disparate data. A model prediction this generated by each of a multitude of machine learning models. For each respective trained model, a trust score is generated based on a data sparseness metric of the data point and a feature importance vector of the respective model. The model predictions and trust scores are received as input to a meta-model that was trained from the trust score and the model prediction of the multitude of trained models over the respective data subset of the disparate data. A combined prediction is generated using the trained meta-model.

### BACKGROUND

Data sparseness refers to a situation where the available dataset for training a machine learning model is insufficient or lacks sufficient diversity to accurately represent all possible scenarios or patterns in the real world. Data sparsity can significantly impact the performance and accuracy of machine learning models, making it challenging to make reliable predictions.

In a sparse dataset, certain classes or categories may have very few examples, or they may be entirely absent. This lack of representation makes it difficult for the model to learn patterns and make accurate predictions for those classes. As a result, the model may struggle to generalize well and may perform poorly on unseen data points.

Data sparsity increases the risk of overfitting, where a model becomes too specialized to the training data and fails to generalize to new data. With limited data, the model may memorize noise or specific instances, leading to poor performance on unseen data. Overfitting can lead to overly optimistic training performance but poor predictive performance on real-world data.

Sparse data may lack diversity and variability in the feature space, resulting in limited coverage of the possible input variations. This restricts the model's ability to capture the full range of patterns and relationships within the data, leading to lower prediction accuracy.

Sparse data can introduce higher uncertainty and instability in model predictions. With limited examples, the model's estimates may fluctuate significantly depending on the available data points. This volatility can make it difficult to rely on the model's predictions and undermine its overall accuracy.

Sparse datasets often struggle to capture rare events or outliers adequately. When these events occur infrequently, the model may not have sufficient examples to learn their distinctive characteristics. As a result, the model may misclassify or overlook such events, leading to reduced prediction accuracy for rare occurrences.

### SUMMARY

In general, one or more aspects of the disclosure are directed to a method for training and ensemble machine learning system. The method includes training a multitude of machine learning models to generate a model prediction. Each model is trained from a respective data subset of a disparate dataset to generate a multitude of trained models. The method also includes generating a trust score for each respective trained model. The trust score is based on a data sparseness metric of the respective subset and a feature importance vector of the respective model. The method additionally includes training a meta-model to generate a combined prediction. The meta-model is trained from the trust score and the model prediction of the multitude of trained models.

In general, one or more aspects of the disclosure are directed to a method for generating a combined prediction using an ensemble machine learning system. The method includes receiving a data point as input to a multitude of trained models. Each model is trained from a respective data subset of a disparate data. The method includes generating a model prediction by each of a multitude of machine learning models. The method includes generating a trust score for each respective trained model. The trust score is based on a data sparseness metric of the data point and a feature importance vector of the respective model. The method additionally includes receiving the model predictions and the trust scores as input to a trained meta-model. the meta-model is trained from the trust score and the model prediction of the multitude of trained models over the respective data subset of the disparate data. The method further includes generating a combined prediction using the trained a meta-model.

In general, one or more aspects of the disclosure are directed to a payroll monitoring system comprising a data repository, and ensemble machine learning model, and a payroll processor. The data repository stores a disparate dataset. The ensemble machine learning model configured to receive a data point as input to a multitude of trained models. each model is trained from a respective data subset of the disparate dataset;

The ensemble machine learning model is further configured to generate a model prediction by each of a plurality of machine learning models. For each respective trained model, the ensemble machine learning model generates a trust score that is based on a data sparseness metric of the data point and a feature importance vector of the respective model. The ensemble machine learning model is configured to receive the model predictions and the trust scores as input to a trained meta-model. The meta-model is trained from the trust score and the model prediction of the multitude of trained models over the respective data subset of the disparate data. The ensemble machine learning model is configured generate a combined prediction using the trained a meta-model. The payroll processor configured to dynamically control processing of payroll based on the combined prediction.

Other aspects of the invention will be apparent from the following description and the appended claims.

### BRIEF DESCRIPTION OF DRAWINGS

FIG. 1A and FIG. 1B show a computing system in accordance with one or more embodiments of the invention.

FIG. 2 shows a method of training a machine learning model ensemble shown according to one or more embodiments.

FIG. 3 shows a method of generating a combined prediction using an ensemble machine learning system shown or according to one or more embodiments.

FIG. 4A and FIG. 4B shows a Venn diagram and a tabular chart comparing a disparate data set collected from disparate data sources.

FIG. 5A and FIG. 5B show test results for a first classification model.

FIG. 6A and FIG. 6B show test results for a second classification model.

FIG. 7A and FIG. 7B show test results for a third classification model.

FIG. 8 shows test results for and ensemble classification model.

FIG. 9 shows a use case scenario for risk analysis using multi-view stacking machine learning.

FIG. 10A and FIG. 10B show a computing system in accordance with one or more embodiments of the invention.

Like elements in the various figures are denoted by like reference numerals for consistency.

### DETAILED DESCRIPTION

Traditionally, ensemble machine learning models for binary classification train a different model that covers each specific product data domain. A meta-learner is then used to combine individual model's prediction results. One way to frame this problem is to train a machine learning model (binary classification) that uses all the historical information collected for the customers to generate feature datasets to predict corresponding risk labels. However, such approach is often found be sub-optimal because it lacks understanding the nature of the underlying data sources. In other words, some data sources might be more predictive than the others in certain areas. Additionally, the “curse of dimensionality” may occur when the number of input features are too large. Alternatively, multiple ML models of different types (such as logistic regression, random forest, boosting tree, etc.) may be trained and majority voting used to combine the predicted results from all individual models.

Multi-view stacking is a machine learning technique that involves training multiple models on different views or perspectives of the same data, and then combining their predictions to make final prediction. This approach can improve the performance of the models by leveraging the strengths of each individual model and reducing their weaknesses. In multi-view stacking, the models are trained independently of one another, and the final prediction is made by combining the predictions of all the models using a meta-model, which is trained on the predictions of the individual models. This technique can be useful in a variety of applications, including image/video classification and natural language processing.

In the exemplary embodiments described herein, a machine learning system is provided that extends multi-view stacking technique by adding a feature importance weighted trust score and is applicable in the context of risk assessment where user's profile data is collected from multiple sources with a variety of data availability, due to the fact that users choose to use certain products based on their needs.

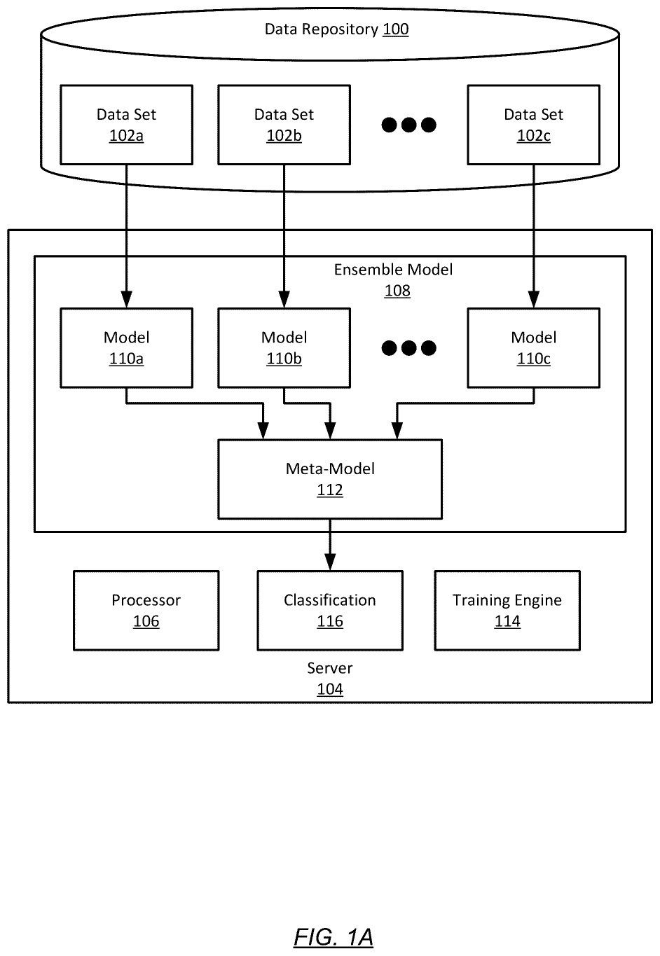

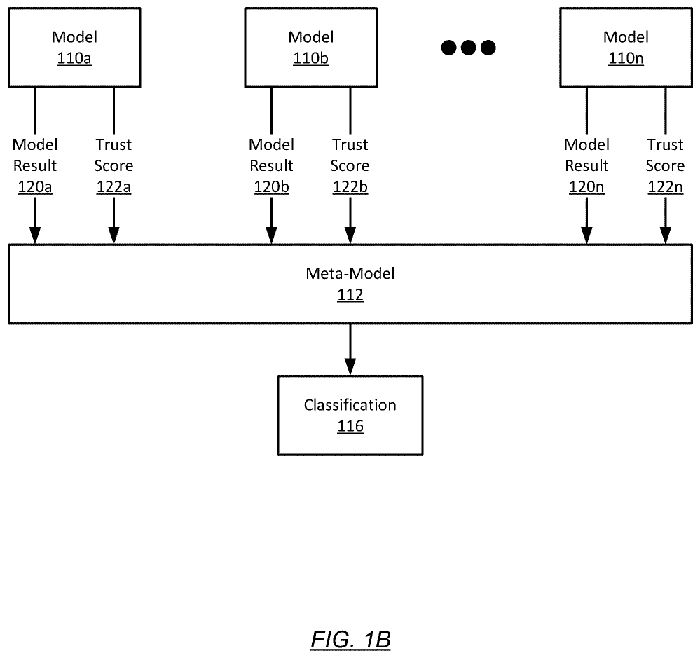

Turning to FIG. 1A, a computing system is shown in accordance with one or more embodiments. The computing system includes a data repository (100). In one or more embodiments of the invention, the data repository (100) is any type of storage unit and/or device (e.g., a file system, database, data structure, or any other storage mechanism) for storing data. Further, the data repository (100) may include multiple different, potentially heterogeneous, storage units and/or devices.

As shown, the data repository (100) stores one or more datasets. The one or more datasets include dataset (102a), dataset (102b), and dataset (102n). For the sake of simplicity and clarity, only three data sets are shown. However, it will be appreciated that more or fewer data sets may be utilized depending on the particular embodiment.

Each of data sets (102a, 102b, 102n) is a collection of data that is organized in a specific way, typically with a defined structure or format, for the purpose of facilitating analysis, processing, or other types of manipulation. The data in data sets (102a, 102b, 102n) may be of various types, including numerical, categorical, textual, or multimedia data. A dataset may be created by collecting data from a variety of sources, such as surveys, experiments, or observations, and may be used for a wide range of applications, such as training machine learning models, conducting statistical analysis, or testing hypotheses.

The datasets (102a, 102b, 102n) may be disparate datasets, different subsets, or different views of the same dataset generated and accessed using one or more different applications. As may be known in the art, disparate data sets refer to collections of data that are distinct and heterogeneous, typically with different structures, formats, and/or sources. These datasets may contain different types of data, such as numerical, categorical, textual, or multimedia data, and may be stored in different locations or formats, using different software or hardware systems. Disparate datasets may also have different levels of quality, accuracy, completeness, or reliability, and may require different methods of processing or analysis.

For example, each of the data sets (102a, 102b, 102n) may represent a table of data stored in the structured query language (SQL) format. In an SQL database, a row represents a single record or instance of data within a table. Each row is identified by a unique identifier, known as the primary key, which distinguishes it from all other rows in the table. A column represents a specific attribute or field within a table, and contains a specific type of data, such as text, numbers, dates, or binary data. Each column is identified by a column name and data type, which define the kind of data that may be stored in that column.

A data element, also known as a cell, is the intersection of a row and a column, and contains a single value corresponding to the specific attribute for that row. Each data element within a table is uniquely identified by its row and column and can be accessed using SQL queries.

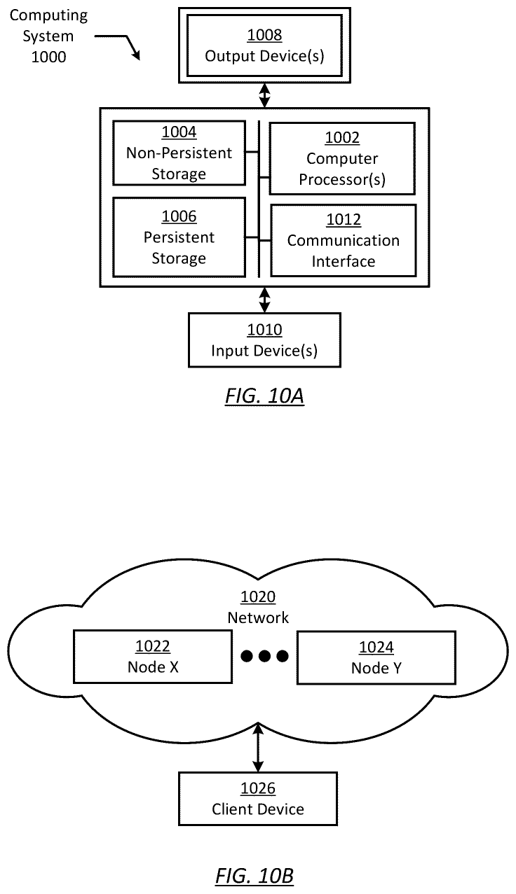

The system of FIG. 1 also includes a server (104). The server is one or more computing systems, operating alone or in a distributed computing environment. An example of the server (104) is shown as the computing system shown in FIG. 10A.

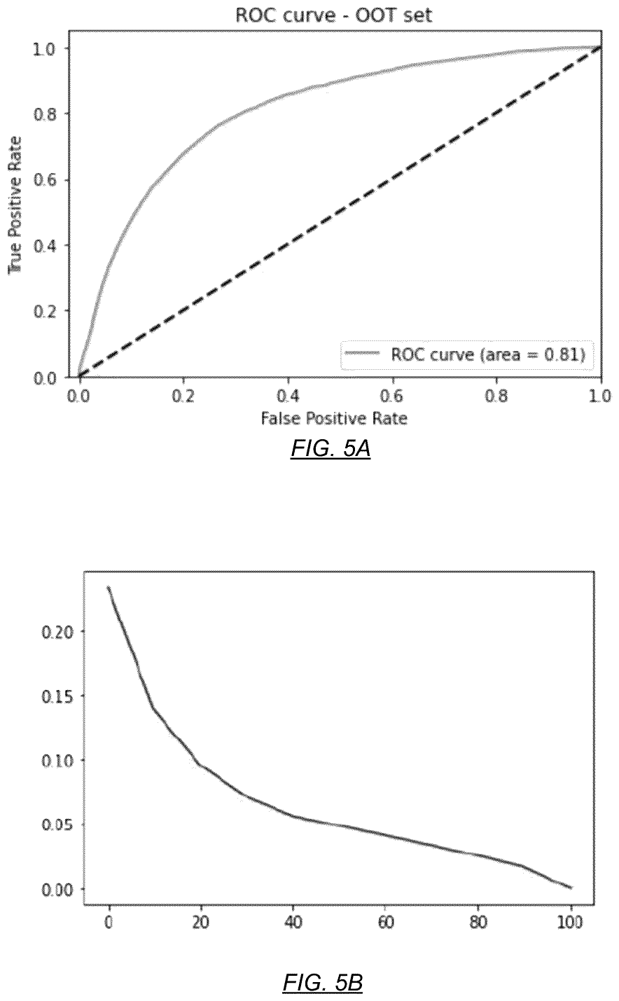

The server (104) includes a processor (106). The processor (106) is one or more hardware or virtual processors, possibly executing in a distributed computing environment. An example of the processor (106) is described with respect to FIG. 5A. The server (104) also includes an ensemble model (108).

The ensemble model (108) is one or more machine learning models. If the ensemble model (108) includes more than one machine learning model, then at least some of the machine learning models accept, as input, the output of another machine learning models. The one or more embodiments contemplate that the ensemble model (108) can be a single machine learning model including multiple layers of different types of machine learning models, the one or more embodiments also may be viewed in some cases as multiple machine learning models acting in concert. Hence the ensemble model (108) may be interpreted as a single machine learning model in some cases, and as multiple machine learning models operating in concert in other cases.

In one or more embodiments, the ensemble model (108) may use multi-view stacking. Multi-view stacking is a machine learning technique that involves combining predictions from multiple models (110a, 110b, 110n) trained on different subsets or views of the same dataset. In multi-view stacking, instead of using a single set of features, multiple subsets or views of the dataset are used to train multiple base models. Each view may contain a different subset of features or represent the data in a different way. For example, in image classification, one view may use raw pixel values, while another view may use preprocessed features extracted using a convolutional neural network.

The predictions of the base models (110a, 110b, 110n) trained on each view are combined using a meta-model (112), which can be a simple linear regression or a more complex neural network. Meta-model (112) leverages the complementary information present in each view to improve the accuracy of classifications (116) predicted by ensemble model (108). Given adequate selection of views and base models to ensure diversity and complementary, multi-view can provide improvements in various applications, including classification, natural language processing, and speech recognition.

Referring now to FIG. 1B, the one or more embodiments recognize that each data sets (102a, 102 b, 102n) may have different degrees of data sparseness. As used herein and is generally known in the art, data sparseness refers to a situation where a substantial portion of the data has missing or zero values for many of its features. In other words, there are many empty cells in the data matrix. Data sparseness can happen due to assorted reasons, such as incomplete data collection, data entry errors, or simply because some features are not applicable to some data points.

Data sparseness can have a significant impact on machine learning algorithms and statistical models because it reduces the amount of information available for learning patterns and making accurate predictions. Sparse data can also introduce bias and noise in the model if not managed properly. Dealing with data sparseness requires specialized techniques, such as imputation, regularization, feature selection, and dimensionality reduction.

To address data sparseness across data sets (102a, 102b, 102n), the one or more embodiments utilize a trust score (120a, 120b, 120n) based in part on data sparseness for the individual data sets. The trust score is a proxy measure of how trustworthy each individual model prediction. In addition to model outputs trust score (120a, 120b, 120n), training engine ABC uses trust scores (120a, 120b, 120n) to train meta-model ABC.

In some embodiments, the trust score for each model is calculated as a dot product combination of a feature importance vector t and a sparsity matrix H. In other words:

$$TS = [ H ] \cdot [ {i}^{d} ] \qquad Eq . 1$$

### Wherein:

TS is the trust score;
i^{d} is a feature importance vector; and
H is a feature presence indicator matrix, calculated as:

$$H = {\{ 0 , 1 \}}^{n \cdot d} \qquad Eq . 2$$

The choice of a specific feature importance vector may depend on the specific problem and the type of model used. In some embodiments, the Importance vector can be, for example, a Gini Importance vector calculated based on an achieved impurity reduction. For example, in a random forest model, the Gini Importance measures the total amount of impurity reduction achieved by a feature across all the trees in the forest. The Gini Importance of a feature is calculated as the sum of the Gini Impurities that would be reduced if that feature were not available for splitting in all the trees of the forest. The Gini Importance can be used to rank the features by importance and to select the most relevant features for building a more efficient model.

In other embodiments, the feature importance vector Can be a weight importance and/or gain importance from the XGBoost model. XGBoost is a gradient boosting machine learning algorithm that uses decision trees as base learners. The feature importance in XGBoost is calculated based on the number of times each feature is used to split the data across all the trees in the ensemble.

The XGBoost weight importance, or more generally Information Gain or Entropy importance, measures the number of times a feature is used to split the data across all the trees in the ensemble. Features with high weight importance are considered more important for making predictions.

The XGBoost gain importance, or more generally gain importance, measures the average gain in training loss achieved by a feature when it is used for splitting the data. The gain is calculated as the reduction in training loss achieved by the split weighted by the number of samples in the split. Features with high gain importance are considered more informative and useful for making accurate predictions.

Other feature important factors that can be utilized, include a permutation importance that measures the decrease in a model's performance (e.g., accuracy, F1 score, etc.) when a feature's values are randomly permuted; SHapley Additive exPlanations (SHAP) computing the contributions of each feature to the model's predictions based on Shapley values from cooperative game theory; and L1-based feature selection that encourages models to use a smaller subset of features by adding a penalty term to the objective function proportional to the sum of the absolute values of the feature coefficients.

The feature presence indicator matrix H is an indication of data sparseness for data attributes taken into account by the feature importance vector i^{d}. In other words, H indicates the presence or absence of important data attributes (as determined by the feature importance vector) within a particular data set.

As shown, the meta-model (112) is trained using model results (120a, 120b, 120n) and trust scores (122a, 122b, 122n) of the individual models. Thus, once trained, meta-model (112) weighs model results for the individual models in part based on the presence or absence of features from the data. In this manner, meta-model (112) discounts individual model results when important features are missing from the data set.

While FIG. 1A and FIG. 1B show a configuration of components, other configurations may be used without departing from the scope of the invention. For example, various components may be combined to create a single component. As another example, the functionality performed by a single component may be performed by two or more components.

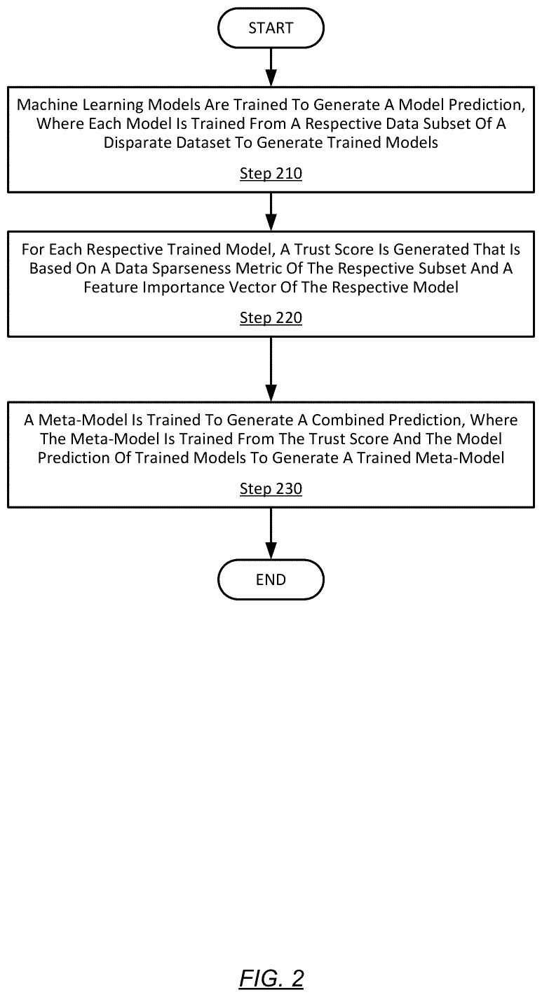

Referring now to FIG. 2, a method of training a machine learning model ensemble is shown according to one or more embodiments. The method of FIG. 2 may be implemented using the system shown in FIG. 1A and FIG. 1B.

At step 210, a multitude of machine learning models is trained to generate a model prediction. each model is trained from a respective data subset of a disparate dataset to generate a multitude of trained models.

The disparate data sets can be compiled from a multitude of disparate data sources. These data sources may include, for example, different databases, spreadsheets, or other data storage systems. The data may be in different formats and may require preprocessing to be used in one or more of the machine learning algorithms.

Once the disparate dataset has been compiled, it is divided into different data subsets, with each subset representing a different view of the data. For example, one subset may correspond to demographic data, while another subset may correspond to behavioral data. Each data subset is used to train a respective machine learning model.

The machine learning models are trained using various algorithms and techniques to generate a model prediction. In this process, the models are trained from a respective data subset of a disparate dataset, which is compiled from a multitude of disparate data sources. Each data subset is a respective view of the disparate data, meaning that a respective view represents a different source of information about the data.

At step 220, a trust score is generated for each respective trained model. The trust score is based on a data sparseness metric of the respective subset and a feature importance vector of the respective model.

The data sparseness metric is a matrix that represents whether a certain feature is missing for data points in the respective data subset. In other words, the data sparseness metric refers to the amount of missing data in the subset used to train the respective model. When there is a high degree of missing data, it can be more difficult to generate an accurate model prediction. The data sparseness metric helps to quantify the degree of missing data and factor it into the trust score calculation.

The feature importance vector represents a relative importance of features in a respective data subset used by a respective trained model to generate the model result. In other words, the feature importance vector refers to the importance of different features or variables in generating the model prediction. Some features may be more important than others in generating an accurate prediction, and the feature importance vector helps to quantify the relative importance of each feature. This information is also used to factor into the trust score calculation.

To generate the trust score for each respective trained model, the data sparseness metric and feature importance vector are combined using a suitable algorithm or technique. For example, the trust score can be calculated as described in equations 1 and equation 2 above. As described in equations one and two, the trust score is a dot product of the data sparseness metric and the feature importance vector The resulting trust score reflects the degree of confidence that can be placed in the respective model's prediction.

At step 230, a meta-model is trained to generate a combined prediction. the meta-model is trained from the trust score and the model prediction of the multitude of trained models to generate a trained meta-model.

The meta-model is trained using the trust scores and model predictions generated by the multitude of trained models. Training the meta-model may utilize various machine learning algorithms and techniques, and involve parameter tuning, cross-validation, and other techniques to optimize the performance of the meta-model.

The meta-model takes as input the trust scores and model predictions generated by the trained models and uses them to generate a single, combined prediction. In other words, the meta-model combines predictions and trust scores from each of the individual models to generate a final prediction. The use of multiple machine learning models helps to increase the accuracy and reliability of the prediction.

The meta-model increases the accuracy and reliability of the prediction by taking into account the trust scores and model predictions generated by multiple trained models. By combining the predictions from multiple models, the meta-model can help to mitigate the impact of overfitting and identify patterns and correlations that may not be apparent from a single view of the data.

The trust scores are based on two principal factors: the data sparseness metric of the respective subset and the feature importance vector of the respective model. The use of trust scores helps to quantify the level of confidence that can be placed in the model prediction and can lead to more informed decision-making in a variety of real-world use cases.

In some embodiments, the multitude of trained models and the trained meta-model are deployed to an enterprise environment. For example, after the models have been trained and optimized, they are deployed to an enterprise environment to make predictions on new data.

The enterprise environment may be any business or organization that generates large amounts of data and requires accurate predictions to make informed decisions. For example, the enterprise environment could be a financial institution that needs to make investment decisions based on market trends or a healthcare organization that needs to diagnose patients based on medical data.

Deploying the multitude of trained models and the trained meta-model to the enterprise environment involves integrating them into the existing software infrastructure. Once the models are deployed, they can be used to make predictions on new data in real-time. The models take as input the relevant data and generate a prediction based on the trained meta-model. The predictions generated by the models can be used to make informed decisions in the enterprise environment.

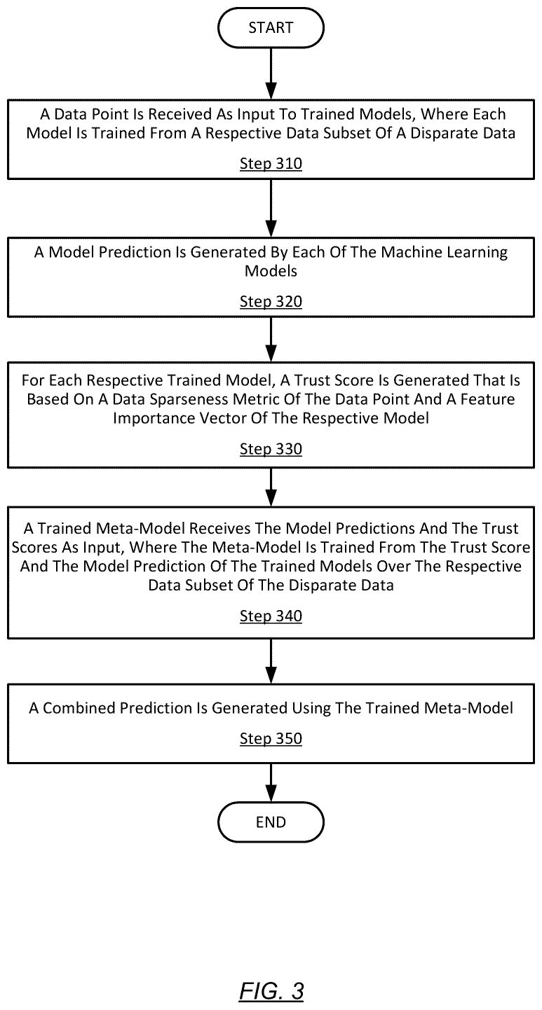

Referring now to FIG. 3, a method of generating a combined prediction using an ensemble machine learning system is shown or according to one or more embodiments. The method of FIG. 3 may be implemented using the system shown in FIG. 1A and FIG. 1B.

At step 310, a data point is received as input to a multitude of trained models. Each model is trained from a respective data subset of a disparate data. For example, each data subset can be a respective view of a disparate data compiled from a multitude of disparate data sources.

The data point can be received, for example, as request from a client device via an interface. In this context, the interface refers to a communication channel that enables the client device to provide the data point to the ensemble machine learning system. The interface may enable the system to be integrated with other software systems and applications. The interface can take various forms, including an API (Application Programming Interface), a GUI (Graphical User Interface), or other means of data exchange.

For example, when the ensemble machine learning system is deployed in an enterprise environment, an API may be provided to enable other software systems to interface with the ensemble system and provide data points for analysis. Similarly, when the ensemble system is designed for consumer-facing applications, a GUI may be provided to allow users to input data points directly into the system.

The data point is received into a multitude of trained models. By using multiple trained models, each optimized for a specific data subset, the ensemble machine learning system can generate multiple predictions based on different aspects of the input data point. The ensemble may allow for a more accurate and comprehensive analysis of the data, as each model is designed to capture different relationships and patterns within the data. By optimizing the models for specific data subsets and using diverse data sources, the system can generate more accurate and comprehensive predictions, improving the quality of decision-making in a variety of applications.

For example, by using disparate data subsets, the ensemble machine learning system can incorporate data from different sources and take into account a wider range of variables. This can improve the accuracy and reliability of the predictions by accounting for factors that may be overlooked by a single model or data source.

At step 320, each of a multitude of machine learning models generates a model prediction from the data point. Each of the multitude of machine learning models in the ensemble system generates a prediction based on the input data point. These predictions may be generated using different algorithms or may be optimized for different data subsets within the larger data set.

At step 330, a trust score is generated for each respective trained model. The trust score is based on a data sparseness metric of the data point and a feature importance vector of the respective model. As described above, the data sparseness metric can be a matrix that represents whether a certain feature is missing for data point in the respective data subset. the feature importance vector represents a relative importance of features in a respective data subset used by a respective trained model to generate the model result. the trust score is a dot product of the data sparseness metric and the feature importance vector.

At step 340, a trained meta-model takes the model predictions and the trust scores as input. the meta-model is trained from the trust score and the model prediction of the multitude of trained models over the respective data subset of the disparate data.

At step 350, the trained a meta-model generates a combined prediction for the data point. By generating multiple predictions using different machine learning models, the ensemble system is able to take advantage of the strengths of each model and generate a more accurate prediction that considers data sparseness. The ensemble system can then combine these individual predictions to arrive at a final prediction that considers a wider range of factors than would be possible with a single model. In some embodiments, the combined prediction can then be returned as a response to the client device via the interface.

While the various steps in the flow charts of FIG. 2 and FIG. 3 are presented and described sequentially, at least some of the steps may be executed in different orders, may be combined, or omitted, and at least some of the steps may be executed in parallel. Furthermore, the steps may be performed actively or passively.

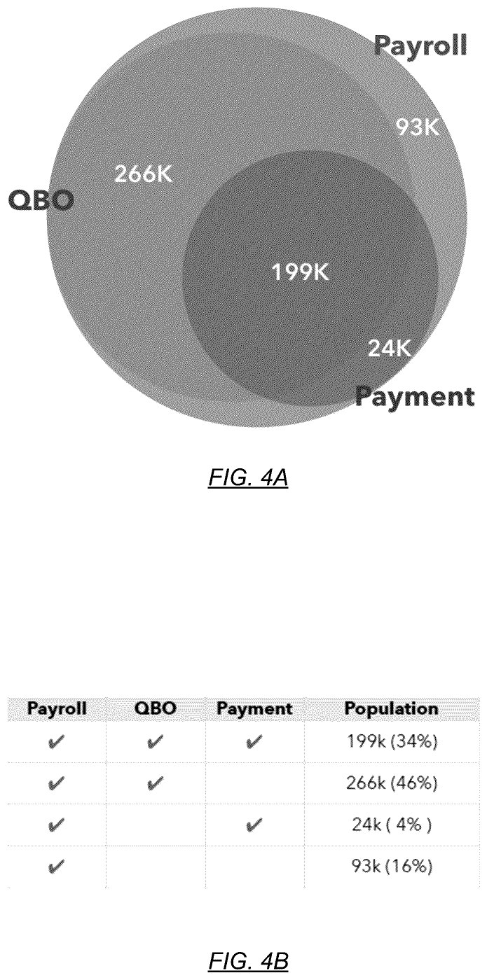

The following examples are for explanatory purposes only and not intended to limit the scope of the invention. FIG. 4 through FIG. 8 illustrate one example of an ensemble model utilized in the context of payroll processing.

FIG. 4A depicts a Venn diagram comparing a disparate data set collected from disparate data sources. in this example, the base data is provided for online payroll accounts enrolling in active direct deposit (DD) service. The base data was generated from the daily snapshot of the online QB payroll US employers who are of active direct deposit (DD) service at each snapshot. Employers in the training data set were classified based on processed payroll DD checks in 3 months and had at least one write-off automated clearinghouse (ACH) withdrawal when payroll was processed for the employer. Details of the overlapping data sets are further shown in FIG. 4B.

FIG. 5 through FIG. 7 show test results in classifications of data items using only one or more base predictor machine learning models.

FIG. 5A and FIG. 5B illustrate test results for a first classification model trained using give me a deposit account labels. Features of the data set can include average amounts, variations, and/or trends measured at various intervals (i.e., 30 days, 120 days, 270 days, 360 days), for bank balance, Gini coefficient revenue, direct deposit account balances, direct deposit account revenue, income taxation, credit card payments, etc.

FIG. 5A is a Receiver Operating Characteristic (ROC) curve of a binary classifier algorithm trained using the payroll labels. It is a plot of the true positive rate (TPR) against the false positive rate (FPR) at different classification thresholds. As shown, the trained classifier model has area under the ROC curve (AUC) 0.81. A lift chart for the model is shown in FIG. 5B.

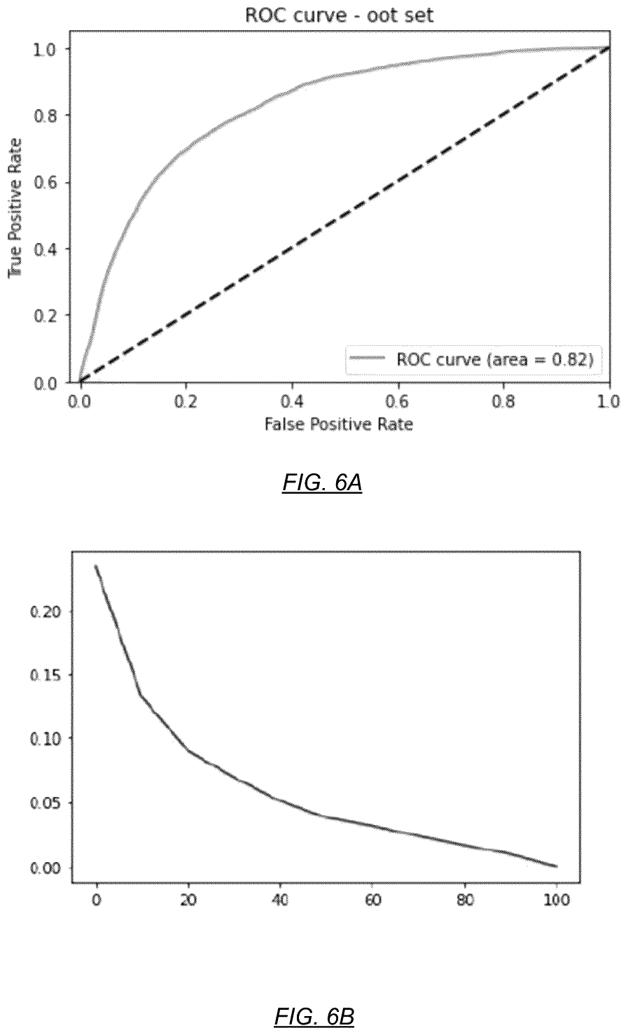

FIGS. 6A and 6B illustrate test results for a second classification model trained using quarterly business credit labels. Features of the data set can include company tenure, credit rating, credit inquiries, days since direct deposit (first/last), etc.

FIG. 6A is a ROC curve of a binary classifier algorithm trained using the p quarterly business credit labels. As shown, the trained classifier model has a ROC AUC 0.82. A lift chart for the model is shown in FIG. 6B.

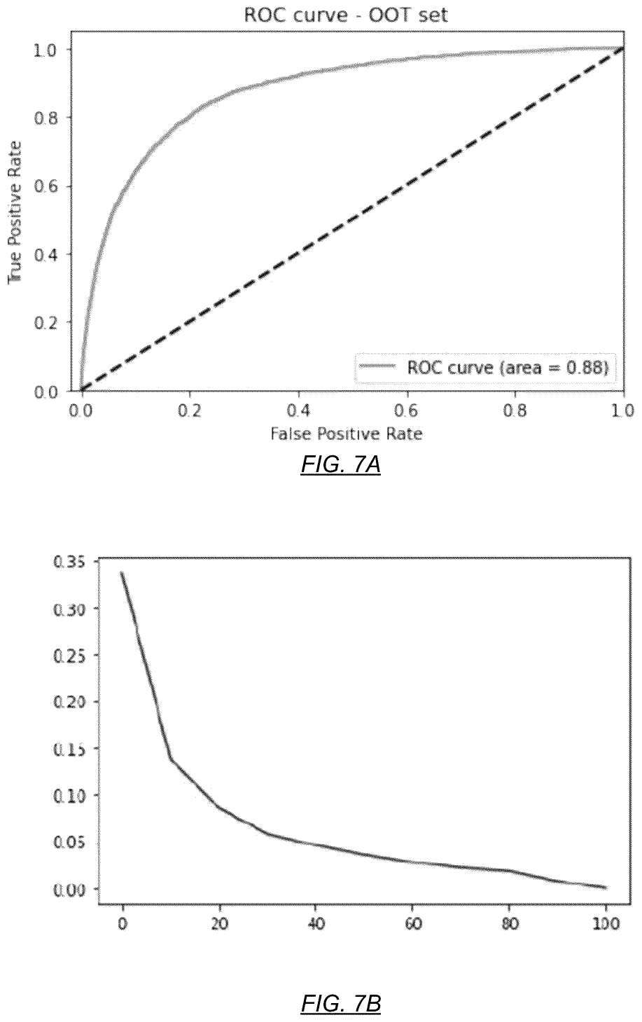

FIG. 7A and FIG. 7B illustrate test results for a third classification model trained using payroll payment labels. Features of the data set can include company tenure, credit rating, credit inquiries, days since direct deposit (first/last), etc.

FIG. 7A is a ROC curve of a binary classifier algorithm trained using the payroll payment labels. As shown, the trained classifier model has a ROC AUC 0.88. A lift chart for the model is shown in FIG. 7B.

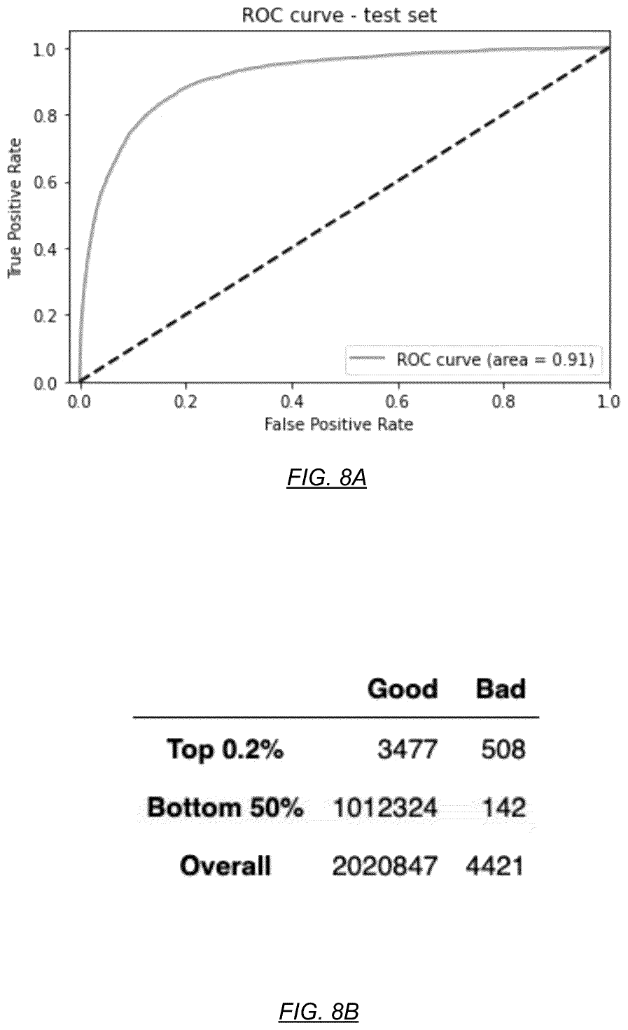

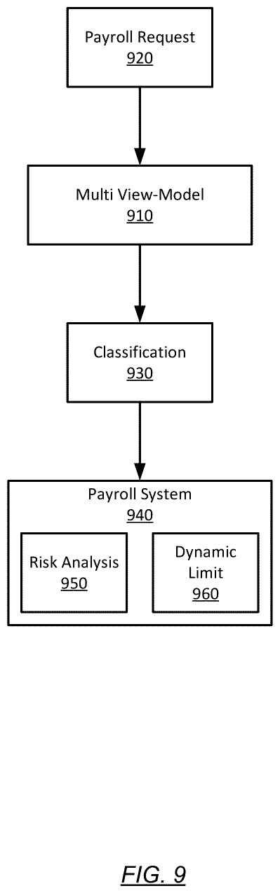

FIG. 8 illustrates test results for an ensemble classification model trained using classification outputs of the models of FIG. 5 through FIG. 7, as well as trust scores generated, therefore. As shown, the ROC AUC for the ensemble model of FIG. 9 is 0.91. The model exhibited a high precision with a low rate of false negatives (0.014%). Thus, the ensemble model of FIG. 8 represents a significant improvement over the individual models of FIG. 5 through FIG. 7.

FIG. 9 illustrates a use case scenario for risk analysis using multi-view stacking machine learning on disparate data sets can be demonstrated in the context of Payroll processing.

Payroll processing companies play a crucial role in ensuring that employees are paid accurately and on time. One of the biggest risks that these companies face is when an employer's bank account does not have sufficient funds to cover their employees' payroll. This situation can result in significant financial losses for the payroll processing company, as well as negative impacts on employee satisfaction and trust.

Multi-view model (910) is an example of ensemble model (108) of FIG. 1. Multi-view model (910) can include multiple machine learning models, each trained on a different subset of the data, or view. The data can be collected from disparate sources including historical payroll data, bank statements, financial statements, credit reports, historical payroll processing data and other financial data sources. Trust scores are generated for each individual model based on a data sparseness metric of the respective subset and a feature importance vector of the respective model. A meta-model is trained from the predictions and trust scores of the individual models.

Once trained, the multi-view model (910) can be deployed to an enterprise environment and used to classify incoming payroll requests (920) in real-time. The classification (930) generated by multi-view model is used by the payroll system (940) when determining a risk analysis (950), such as the risk analysis of employer insufficient funds. Based on the risk analysis, the payroll system may set dynamic limits (960) for credit amounts and make a payroll decision on whether to process the payroll request.

Using multi-view model (910), a payroll processing company can perform risk analysis of an employer's insufficient funds and make informed predictions about the likelihood of this risk occurring. By deploying the trained models and meta-model to an enterprise environment and continuously monitoring their performance, the company can reduce the risk of financial losses. For example, the payroll processing company can set up alerts to notify them when there is an elevated risk of insufficient funds, allowing them to take action to mitigate the risk. They can also continuously monitor the models' performance and retrain them as necessary to ensure that they remain accurate and dependable.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 10A, the computing system (1000) may include one or more computer processors (1002), non-persistent storage (1004), persistent storage (1006), a communication interface (1012) (e.g., Bluetooth interface, infrared interface, network interface, optical interface, etc.), and numerous other elements and functionalities that implement the features and elements of the disclosure. The computer processor(s) (1002) may be an integrated circuit for processing instructions. The computer processor(s) may be one or more cores or micro-cores of a processor. The computer processor(s) (1002) includes one or more processors. The one or more processors may include a central processing unit (CPU), a graphics processing unit (GPU), a tensor processing unit (TPU), combinations thereof, etc.

The input devices (1010) may include a touchscreen, keyboard, mouse, microphone, touchpad, electronic pen, or any other type of input device. The input devices (1010) may receive inputs from a user that are responsive to data and messages presented by the output devices (1008). The inputs may include text input, audio input, video input, etc., which may be processed and transmitted by the computing system (1000) in accordance with the disclosure. The communication interface (1012) may include an integrated circuit for connecting the computing system (1000) to a network (not shown) (e.g., a local area network (LAN), a wide area network (WAN) such as the Internet, mobile network, or any other type of network) and/or to another device, such as another computing device.

Further, the output devices (1008) may include a display device, a printer, external storage, or any other output device. One or more of the output devices may be the same or different from the input device(s). The input and output device(s) may be locally or remotely connected to the computer processor(s) (1002). Many different types of computing systems exist, and the aforementioned input and output device(s) may take other forms. The output devices (1008) may display data and messages that are transmitted and received by the computing system (1000). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (1000) in FIG. 10A may be connected to or be a part of a network. For example, as shown in FIG. 10B, the network (1020) may include multiple nodes (e.g., node X (1022), node Y (1024)). Each node may correspond to a computing system, such as the computing system shown in FIG. 10A, or a group of nodes combined may correspond to the computing system shown in FIG. 10A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1000) may be located at a remote location and connected to the other elements over a network.

The nodes (e.g., node X (1022), node Y (1024)) in the network (1020) may be configured to provide services for a client device (1026), including receiving requests and transmitting responses to the client device (1026). For example, the nodes may be part of a cloud computing system. The client device (1026) may be a computing system, such as the computing system shown in FIG. 10A. Further, the client device (1026) may include and/or perform all or a portion of one or more embodiments of the invention.

The computing system of FIG. 10A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

1. A method for training an ensemble machine learning system, the method comprising:
training a plurality of machine learning models to generate a model prediction, wherein each model is trained from a respective data subset of a dataset to generate a plurality of trained models;
for each respective trained model, generating a respective trust score that is based on a data sparseness metric of the respective data subset and a feature importance vector of the respective trained model; and
training a meta-model to generate a trained meta-model by using a processor to apply the meta-model to the trust scores and the model predictions, generated by the plurality of trained models, to generate a combined prediction that accounts for data sparsity of data points input into the plurality of trained models.

2. The method of claim 1, wherein each data subset is a respective view of a disparate data compiled from a plurality of disparate data sources.

3. The method of claim 1, wherein the data sparseness metric is a matrix that represents whether a certain feature is missing for a data point in the respective data subset.

4. The method of claim 1, wherein the feature importance vector represents a relative importance of features in the respective data subset used by a respective trained model to generate a model result.

5. The method of claim 1, wherein the trust score is a dot product of the data sparseness metric and the feature importance vector.

6. The method of claim 1, further comprising:
deploying, to an enterprise environment, the plurality of trained models and the trained meta-model.

7. A method for generating a combined prediction using an ensemble machine learning system, the method comprising:
receiving a data point as input to a plurality of trained models, wherein each model is trained from a respective data subset of a disparate data;
generating a model prediction by each of a plurality of machine learning models;
for each respective trained model, generating a respective trust score that is based on a data sparseness metric of the respective data subset and a feature importance vector of the respective trained model;
receiving the model predictions and the trust scores generated by the plurality of trained models as input to a trained meta-model, wherein the trained meta-model is trained by applying a meta-model to the trust score and the model prediction of the plurality of trained models over the respective data subset of the disparate data; and
generating the combined prediction using the trained meta-model, wherein the combined prediction accounts for data sparsity of a data point input into the plurality of trained models.

8. The method of claim 7, wherein each data subset is a respective view of the disparate data compiled from a plurality of disparate data sources.

9. The method of claim 7, wherein the data sparseness metric is a matrix that represents whether a certain feature is missing for the data point in the respective data subset.

10. The method of claim 7, wherein the feature importance vector represents a relative importance of features in the respective data subset used by a respective trained model to generate a model result.

11. The method of claim 7, wherein the trust score is a dot product of the data sparseness metric and the feature importance vector.

12. The method of claim 7, further comprising:
receiving the data point as a request from a client device via an interface; and
return the combined prediction as a response to the client device via the interface.

13. A payroll monitoring system comprising:
a data repository storing a disparate dataset; and
an ensemble machine learning model configured to:
receive a data point as input to a plurality of trained models, wherein each model is trained from a respective data subset of the disparate dataset;
generate a model prediction by each of a plurality of machine learning models;
for each respective trained model, generate a trust score that is based on a data sparseness metric of the data point and a feature importance vector of the respective model; and
receive the model predictions and the trust scores as input to a trained meta-model, wherein the trained meta-model is trained by applying a meta-model to the trust score and the model prediction of the plurality of trained models over the respective data subset of the disparate dataset;
generate a combined prediction using the trained meta-model; and
a payroll processor configured to dynamically control processing of payroll based on the combined prediction.

14. The system of claim 13, wherein each data subset is a respective view of a disparate dataset compiled from a plurality of disparate data sources.

15. The system of claim 13, wherein each data subset is a respective data set generated by one of a plurality of disparate data sources.

16. The system of claim 13, wherein the data sparseness metric is a matrix that represents whether a certain feature is missing for the data point in the respective data subset.

17. The system of claim 13, wherein the feature importance vector represents a relative importance of features in the respective data subset used by a respective trained model to generate the model result.

18. The system of claim 13, wherein the trust score is a dot product of the data sparseness metric and the feature importance vector.

19. The system of claim 13, further comprising an interface configured to:
receive the data point as a request from a client device; and
return the combined prediction as a response to the client device.
